(19) United States
(12) Patent Application Publication
(10) Pub. No.: US 2008/0304669 A1
(43) Pub. Date: Dec. 11, 2008

(54) RECIPIENT-SIGNED ENCRYPTION CERTIFICATES FOR A PUBLIC KEY INFRASTRUCTURE

(75) Inventor: Larry Bugbee, Kent, WA (US)

Correspondence Address: NovaTech IP Law, 1001 Ave. Pico, Suite C500, San Clemente, CA, 92673, US

(73) Assignee: THE BOEING COMPANY, Irvine, CA (US)

(21) Appl. No.: 11/760,895

(22) Filed: Jun. 11, 2007

(51) Int. Cl. H04L 9/00

(52) U.S. Cl. 380/278

(57) ABSTRACT

In accordance with various embodiments, methods, apparatuses, and articles of manufacture for generating and signing, by a potential recipient, a digital encryption certificate are described herein. In some embodiments, the digital encryption certificate may include a encryption key of an encryption key pair, and may be signed by the potential recipient with a signing key of a signing key pair. The signing key pair may have a second, publicly-accessible signing key associated with a digital signing certificate issued by a party trusted by the potential recipient and one or more potential senders. In various embodiments, potential senders may verify the digital encryption certificate and use the encryption key to encrypt and send digital messages to the potential recipient.

### FIELD

The present invention relates generally to secure communications, and more particularly to encryption key management.

### BACKGROUND

Moving sensitive information confidentially between parties is often difficult and expensive. Some commonly used techniques for such movements include point-to-point dedicated circuits, virtual private networks (VPNs), and secure tunnels using Secure Shell (SSH), Secure Socket Layer/Transport Layer Security (SSL/TLS), or IP Security (IPSEC). These techniques, however, provide no protection for data “at rest”, which may be especially important if the content has not yet been fully delivered (i.e., received by company but not by the named individual) or perhaps written to removable media or a backup system. Encryption of the data independent of the transport mechanism or media may be required to properly protect the information.

Encryption of data can be performed in several ways. One common method is the use of “public key” cryptography. Public key cryptography is based on two keys that are specially designed to work with each other. One of these keys is designated the “private key” and the other is called the “public key”. The private key is held and kept a secret; the public key may be widely distributed. If content is encrypted with the public key, only the private key of that pair is able to decrypt it.

The use of public key pairs creates security concerns, however. A potential sender may have no way of knowing whether a public key belongs to the person it purports to belong to. Therefore, there remains a need in the art to provide a system and method for verifying the identity of a potential recipient and their associated public key.

### SUMMARY

In various embodiments, a potential recipient device of a potential recipient of one or more digital messages may generate a digital encryption certificate, the digital encryption certificate including a first encryption key of an encryption key pair. The potential recipient device may further sign the digital encryption certificate with a first signing key of a signing key pair, the signing key pair having a publicly-accessible second signing key associated with a digital signing certificate issued by a party trusted by the potential recipient and one or more potential senders. Also, in some embodiments, the potential recipient device may place the encryption certificate in a location accessible to potential sender devices of the potential senders.

In various embodiments, a potential sender device of a potential sender of one or more digital messages may receive a digital encryption certificate of a potential recipient, the digital encryption certificate including a first encryption key of an encryption key pair. The potential sender device may verify authenticity of the received digital encryption certificate based on one or both of a public signing key associated with the potential recipient or a digital signing certificate issued by a party trusted by the potential recipient and the potential sender. Also, in some embodiments, the potential sender device may encrypt a digital message to be sent the recipient using the first encryption key and send the encrypted message to the potential recipient.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of the invention, in accordance with various embodiments;

FIGS. 2a-2b are flow charts depicting various embodiments of the invention;

FIG. 3 illustrates an exemplary computing device capable of performing the operations of various embodiments of the present invention;

FIG. 4 illustrates an exemplary digital encryption certificate, in accordance with various embodiments.

### DETAILED DESCRIPTION

Illustrative embodiments of the present invention include but are not limited to methods and apparatuses for generating, by a potential recipient device of a potential recipient (i.e. a user) of one or more digital messages, a user signed encryption certificate (USEC). The user and/or a potential recipient device may then sign the digital encryption certificate with a first signing key of a signing key pair, the signing key pair having a publicly-accessible second signing key associated with a digital signing certificate issued by a party trusted by the potential recipient and one or more potential senders. Upon signing, the potential recipient device may then place the encryption certificate in a location accessible to potential sender devices of the potential senders.

In various embodiments, the illustrative embodiments also or instead may include, but are not limited to, methods and apparatuses for receiving, by a potential sender device of a potential sender of one or more digital messages, a digital signed encryption certificate of a potential recipient, the digital encryption certificate including a first encryption key of an encryption key pair. The potential sender device may then verify authenticity of the received digital encryption certificate based on one or both of a public signing key associated with the potential recipient or a digital signing certificate issued by a party trusted by the potential recipient and the potential sender. Upon verifying, the potential sender device may then encrypt a digital message to be sent the recipient using the first encryption key, and send the encrypted message to the potential recipient.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

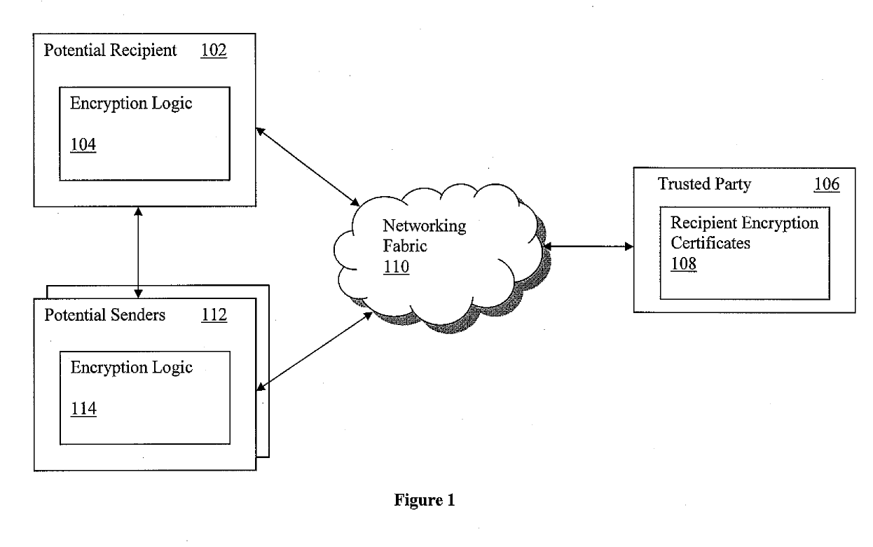

FIG. 1 illustrates an overview of the invention, in accordance with various embodiments. As illustrated, a potential recipient device of a potential recipient 102 of one or more digital messages may generate and sign a digital encryption certificate 108 using encryption logic 104. The digital encryption certificate may include a public encryption key of an encryption key pair generated by the potential recipient 102 device, as well as information identifying the potential recipient 102 device. Optionally, the digital encryption certificate may include a digital signing certificate issued by a trusted party 102 or a reference to such a certificate. Potential recipient 102 device may sign the generated digital encryption certificate 108 with a private signing key of a previously generated signing key pair, the other, public signing key of which is publicly accessible to potential senders. Upon signing the encryption certificate 108, potential recipient 102 device may place the certificate in a location accessible by the one or more potential senders 112. Though that location is illustrated here as trusted party 106, any location on any device accessible by potential sender 112 device(s) may serve as a repository for one or more encryption certificates 108.

As is further shown, one or more potential sender devices of one or more potential senders 112 of digital messages may receive the encryption certificates, retrieving the certificates 108 in some embodiments. Encryption logic 114 of potential sender 112 devices may then verify the authenticity of the digital encryption certificate 108, in some embodiments using the public signing key of the potential recipient 102. In one embodiment, potential sender 112 devices may also check a certificate revocation list of the trusted party 106 to determine the continued validity of the encryption certificate 108. If still valid, potential sender 112 devices may then encrypt digital messages to the potential recipient 102 using the public encryption key of the certificate 108, and may send the encrypted messages to the potential recipient 102, which may then receive and decrypt the messages using the private encryption key of the potential recipient 102.

In various embodiments, potential recipient 102 may be any user or users desiring to engage in secure communication and to receive secure digital messages from potential senders 112. In some embodiments, potential recipient 102 may have a potential recipient device, the device having encryption logic 104 for generating and signing the certificate 108.

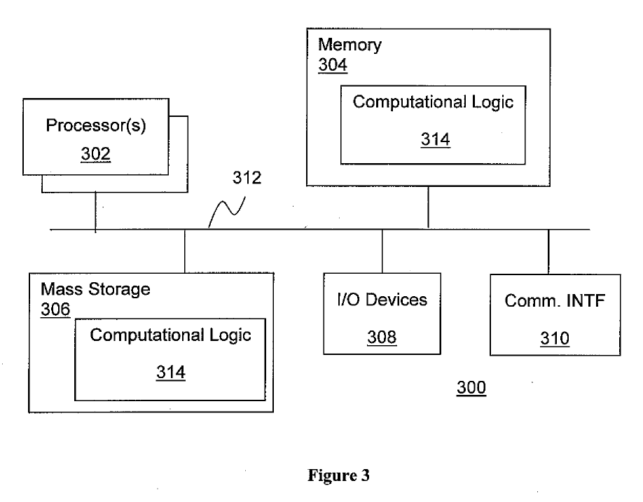

In various embodiments, the potential recipient 102 device may comprise any suitably programmed single- or multi-processor or processor core central processing unit (CPU) computing system. The potential recipient 102 device may be a personal computer (PC), a workstation, a server, a router, a mainframe, a modular computer within a blade server or high-density server, a personal digital assistant (PDA), an entertainment center, a set-top box, a media player, or a mobile device. Potential recipient 102 device may be capable of operating a plurality of operating systems (OS) in a plurality of virtual machines using virtualization technologies. An exemplary single-/multi-processor or processor core potential recipient 102 device is illustrated by FIG. 3, and is described in greater detail below. Hereinafter, including in the claims, processor and processor core shall be used interchangeably, with each term including the other.

In some embodiments, encryption logic 104 or some other logic of the potential recipient 102 device may first generate a signing key pair, including public and private signing keys, and may provide the public signing key, along with identity information, to the trusted party 106. In other embodiments, potential recipient 102 may simply use pre-generated signing keys, which may or may not have been generated by the potential recipient 102 device. In response to providing the public signing key to the trusted party 106, potential recipient 102 may receive a digital signing certificate from the trusted party, signed by the trusted party, for use in verifying potential recipient 102's identity to potential senders 112. The digital signing certificate may include the public signing key and may be located in a place accessible to potential senders 112, such as a data repository server. In some embodiments, any one of the potential recipient 102 device, the trusted party 106, and the potential sender 112 devices may provide such a publicly accessible location. In other embodiments, the publicly accessible location may comprise any web page or network accessible site, or may even include one or more storage media, such as Compact Discs (CDs).

In various embodiments, encryption logic 104 may further be adapted to generate an encryption key pair, which may include a public encryption key and a private encryption key. In one embodiment, the encryption key pair may provide substantially stronger security than the signing key pair, and may be effective, authorized, and/or allowed for a different duration. The potential recipient 102's encryption certificate may identify one or more symmetric encryption algorithm preferences for senders 112 to encrypt digital messages to be used in conjunction with the public encryption key, and for potential recipient 102 device to decrypt the message. In other embodiments, rather than generating the encryption key pair, potential recipient 102 may instead use a pre-generated pair, which may have been generated by potential recipient 102 device or by another device. Upon generating the encryption key pair, the potential recipient 102 device may store the private encryption key in a keystore (not shown) capable of securing the private encryption key. Such a keystore may be local to potential recipient 102 device or may instead be located on a remote device. In one embodiment, potential recipient 102 may also store the private signing key in the keystore. Additionally, in some embodiments, a third party, such as an employer of the potential recipient 102 may require the potential recipient 102 device to place the private encryption key in a key escrow (not shown), which may be local to or remote from the potential recipient 102 device.

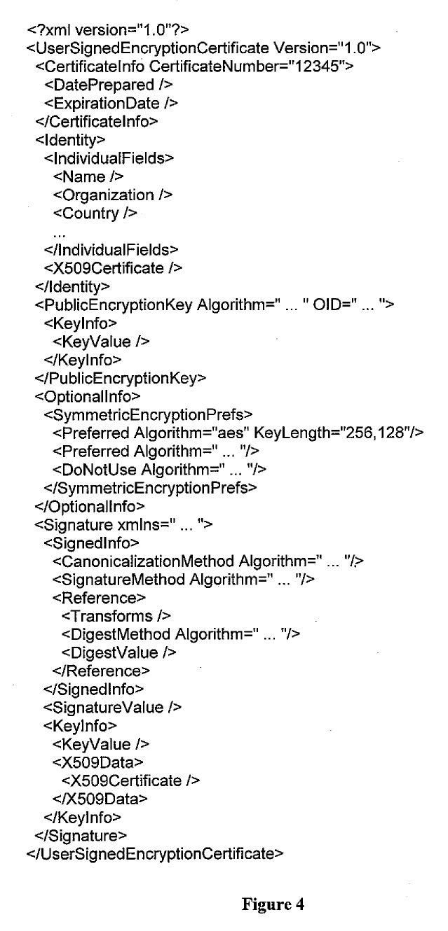

In some embodiments, encryption logic 104, or other logic available to the potential recipient 102 device, may also generate a digital encryption certificate 108. Such a certificate 108 may include identity information about potential recipient 102, the public encryption key of potential recipient 102, an identification of a symmetric encryption algorithm preference or requirement associated with the public encryption key, an expiration date of one or both of the digital encryption certificate 108 and the digital signing certificate, the digital signing certificate, a reference to the digital signing certificate, the date the digital encryption certificate is being prepared and signed, a location for potential senders 112 to look for revocation information, and/or a maximum, minimum, or acceptable key length supported by the potential recipient 102 device (with what is “maximum”, “minimum” and “acceptable” varying from embodiment to embodiment). In one embodiment, certificate 108 may include multiple public encryption keys, such as public encryption keys for two or more of the potential recipient 102, recipient 102's company, and/or recipient 102's group/community. In some embodiments, the encryption certificate may be an X.509 or X.509-like certificate. In other embodiments, the digital encryption certificate 108 may be expressed in an XML or XML-like language, and may conform to an XML signing standard. In yet other embodiments, all or part of the certificate 108 may be expressed in base64 or other encodings/representations. FIG. 4 illustrates an exemplary digital encryption certificate 108.

In various embodiments, encryption logic 104 of the potential recipient 102 device may further sign the digital encryption certificate 108 with the private signing key of the potential recipient 102. In various embodiments, the potential recipient 102 device or a network/system associated with the potential recipient 102 may be cross-certified with other certificate authorities, such as trusted party 106, allowing potential senders 112 to trust signatures from potential recipient 102. Once signed, logic 104 of potential recipient 102 may place the digital encryption certificate 108 in a location accessible to potential sender devices of potential senders 112. The location may be, for example, an online location accessible via the Internet. As shown, the location may be local to trusted party 106. However, in other embodiments, the location may be local to any computing device, including either or none of the potential recipient 102 device or potential sender 112 devices. In yet other embodiments, the publicly accessible location may comprise any web page or network accessible site, or may even include one or more storage media, such as Compact Discs (CDs).

In some embodiments, encryption logic 104 of the potential recipient 102 device may further revoke either or both of the digital encryption certificate 108 and/or the digital signing certificate. Potential recipient 102 may post the revocation in a location identified by the digital encryption certificate 108, or may notify trusted party 106, which may provide notice of the revocation through a publicly-accessible certificate revocation list. The potential recipient 102 may revoke the encryption certificate 108 if the private encryption key is lost, stolen, or in some fashion compromised. In one embodiment, potential recipient 102 may also or instead revoke the digital signing certificate if the private encryption key is stolen.

In various embodiments, the potential recipient 102 device may also receive encrypted digital messages from potential senders 112, the messages encrypted with the public encryption key of potential recipient 102 and the symmetric algorithm. In various embodiments, the symmetric algorithm may be entirely unrelated to the public encryption key. The symmetric algorithm may have been explicitly specified in the digital encryption certificate, or may simply be one of a number of possible algorithms allowed by the digital encryption certificate. For example, the digital encryption certificate may specify algorithms supported by the potential recipient 102 device, or those that are not supported, allowing the sender to select the algorithm. In other embodiments, the digital encryption certificate may not specify the algorithm at all, and both sender 112 and recipient 102 may rely on established standards. Encrypting with the symmetric algorithm may comprise encrypting the message with a symmetric algorithm, such as Advanced Encryption Standard (AES), Twofish, Triple-Digital Encryption Standard (3DES), or any other algorithm known in the art, using a key. In one embodiment, that key may be generated on the spot, and may be a random number. The potential recipient 102 device may then use the private encryption key and symmetric algorithm key to decrypt the digital message and access the message.

As illustrated, trusted party 106 may be a device or devices accessible via networking fabric 110. In some embodiments, trusted party 106 may be certificate authority trusted by the potential recipient 102 and potential senders 112. In such embodiments, the trusted party 106 may receive public signing keys and identity information from potential recipients 102 and may, in response, issue digital signing certificates verifying the potential recipient 102's identity to potential senders 112, and may sign the digital signing certificate. In various embodiments, embodiments, trusted party 106 may act as a data repository, storing the digital signing certificates, public signing keys, and, in one embodiment, digital encryption certificates. Further, in one embodiment, trusted party 106 may be identical to potential recipient 102 device, one of potential sender 112 devices, or may be a computing device associated with a network or business to which potential recipient 102/potential senders 112 belong. In such an embodiment, the trusted party 106 may cross-certify with another certificate authority independent from both of potential recipient 102 and potential senders 112 to guaranty the trustworthiness of the issued signing certificates. Further, in various embodiments, trusted party 106 may publish a certificate revocation list (not shown) in a publicly-accessible location to facilitate potential senders 112 in determining whether a digital certificate has been revoked.

As illustrated, potential recipient 102, potential senders 112, and trusted party 106 may be connected by a networking fabric 110. Networking fabric 110 may be any sort of networking fabric known in the art, such as one or more of a local area network (LAN), a wide area network (WAN), and the Internet. Potential recipient 102, potential senders 112, and trusted party 106 may communicate via networking fabric 110 and may further use any communication protocol known in the art, such as the Hypertext Transfer Protocol (HTTP), and any transport protocol known in the art, such as the Transmission Control Protocol/Internet Protocol (TCP/IP) suite of protocols.

In various embodiments, potential senders 112 may be any users desiring to engage in secure communication and to send secure digital messages to potential recipient 102. In some embodiments, potential senders 112 may have potential sender devices, the devices having encryption logic 114 for receiving and verifying the digital encryption certificates 108 and digital signing certificates. In various embodiments, the same user may be both a potential recipient 102 and a potential sender 112, engaging in secure communication with other potential recipients 102 and other potential senders 112.

In various embodiments, a potential recipient 112 device may comprise any suitably programmed single- or multi-processor or processor core central processing unit (CPU) computing system. A potential recipient 112 device may be a personal computer (PC), a workstation, a server, a router, a mainframe, a modular computer within a blade server or high-density server, a personal digital assistant (PDA), an entertainment center, a set-top box, a media player, or a mobile device. Potential recipient 112 devices may each be capable of operating a plurality of operating systems (OS) in a plurality of virtual machines using virtualization technologies. An exemplary single-/multi-processor or processor core potential recipient 112 device is illustrated by FIG. 3, and is described in greater detail below.

As illustrated, encryption logic 114 of a potential sender 112 device may receive or retrieve a digital encryption certificate 108 or digital signing certificate, which may be located in a publicly-accessible location. Exemplary digital encryption certificates 108 are described above in greater detail. Once retrieved, the potential sender 112 may verify the authenticity of the digital encryption certificate, which may comprise verifying the signature of the certificate. To verify the signature, the potential sender 112 may use the public signing key associated with the potential recipient 102. Once the signature is verified, the potential sender 112 may verify the signing certificate embedded in or referenced by the digital encryption certificate 108. Other authenticating operations associated with signing certificates are well known in the art, and accordingly will not be described further.

In various embodiments, the encryption logic 114 of a potential sender 112 device may further determine whether the digital encryption certificate 108 is revoked and/or expired. In some embodiments, the potential sender 112 may check expiration dates listed in the digital encryption certificate 108 for both that certificate and for the digital signing certificate. In one embodiment, if either is expired, the potential sender 112 may not use the public encryption key of the digital encryption certificate 108. To determine whether either or both of the certificates is/are revoked, the potential sender 112 may check a certificate revocation list published by the trusted party 106 or a notification location specified by the digital encryption certificate 108. In one embodiment, if either is revoked, the potential sender 112 may not use the public encryption key of the digital encryption certificate 108.

In some embodiments, if both certificates are not expired and not revoked, the potential sender 112 may use the public encryption key of the digital encryption certificate 108 to encrypt a digital message to the potential recipient, and may further use the symmetric encryption algorithm specified by the digital encryption certificate 108 to further encrypt the message. Upon encrypting the message, the potential sender 112 may send the encrypted message to the potential recipient 102.

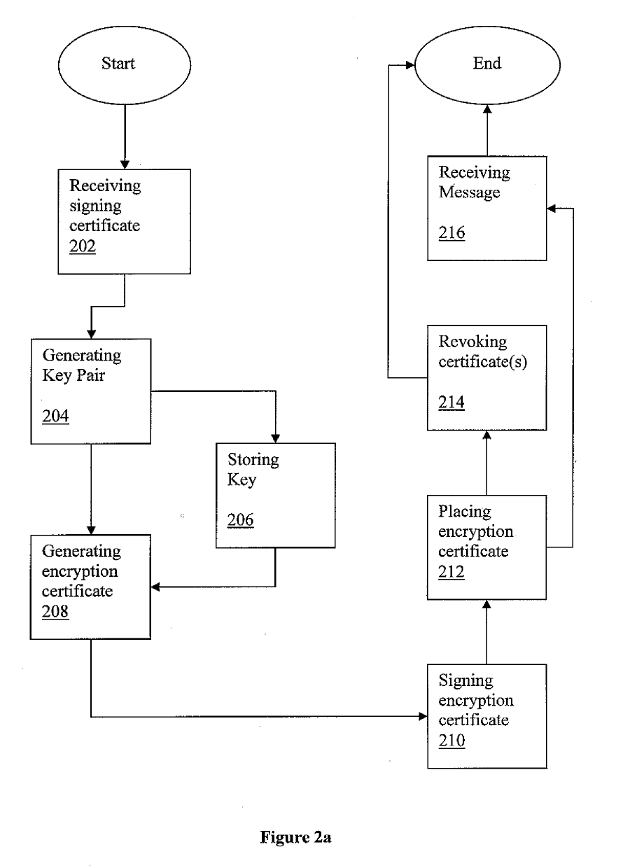

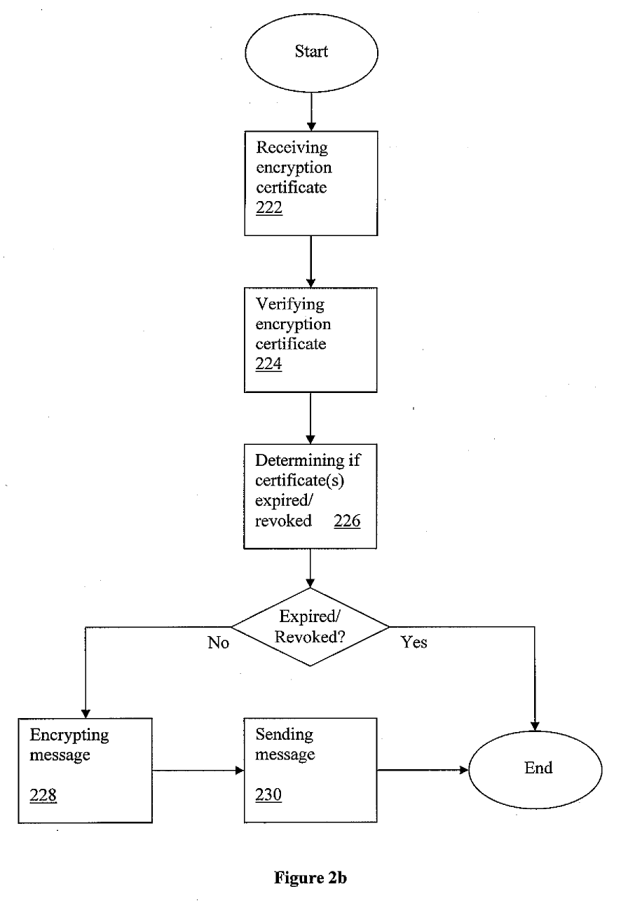

FIGS. 2a-2b are flow charts depicting various embodiments of the invention. FIG. 2a is a flow chart view of one embodiment of the invention, showing a potential recipient generating and signing a digital encryption certificate. As illustrated, a potential recipient device of a potential recipient of one or more digital messages may receive a digital signing certificate from a party trusted by the potential recipient and one or more potential senders, block 202, the trusted party providing the digital signing certificate in response to having previously received, from the potential recipient, a publicly-accessible second signing key of a signing key pair, such as a public key. Upon receiving the digital signing certificate, the potential recipient device may generate an encryption key pair, the encryption key pair comprising a public encryption key and a private encryption key, block 204, wherein a first key of the encryption key pair is the public encryption key. In one embodiment, the potential recipient device may then store the private encryption key in one or both of a keystore and/or a key escrow, block 206.

As is further shown, the potential recipient device may then generate a digital encryption certificate, the digital encryption certificate including the first encryption key of the encryption key pair, block 208. In various embodiments, the digital encryption certificate may further include at least one of (1) potential recipient identity information, (2) an identification of a symmetric encryption algorithm, (3) an expiration date of one or both of the digital encryption certificate and the digital signing certificate, (4) the digital signing certificate, (5) a reference to the digital signing certificate, or (6) a maximum, minimum, or acceptable key length supported by the potential recipient device.

Upon generating the digital encryption certificate, the potential recipient device may then sign the digital encryption certificate with a first signing key of the signing key pair, such as a private signing key, block 210, the signing key pair having the publicly-accessible second signing key, such as a public signing key, associated with the digital signing certificate issued by the trusted party. In some embodiments, the signing key pair includes a public and a private signing key, and said signing the digital encryption certificate with the first signing key comprises signing the digital encryption certificate with the private signing key.

As illustrated, after signing the digital encryption certificate, the potential recipient device may place the encryption certificate in a location accessible to potential sender devices of the potential senders, block 212. Further, at any time, the potential recipient device or some associated device or person may revoke one or both of the digital encryption and/or signing certificates, block 214. The potential recipient device may do so, for example, because a key has been compromised or because the certificate has expired. Lastly, after placing the digital encryption certificate, the potential recipient device may receive a digital message encrypted with the first key of the encryption key pair, such as the public encryption key, and may decrypt the digital message with the second key of the encryption key pair, such as the private encryption key, block 216.

FIG. 2b is a flow chart view of another embodiment of the invention, showing a potential sender verifying a digital encryption certificate and using an encryption key of the certificate to encrypt and send a digital message. As illustrated, a potential sender device of a potential sender of one or more digital messages may receive a digital signed encryption certificate of a potential recipient, the digital encryption certificate including a first encryption key of an encryption key pair, such as a public encryption key, block 222. In some embodiments, the digital encryption certificate may further include at least one of (1) potential recipient identity information, (2) an identification of a symmetric encryption algorithm, (3) an expiration date of one or both of the digital encryption certificate and the digital signing certificate, (4) the digital signing certificate, (5) a reference to the digital signing certificate, or (6) a maximum, minimum, or acceptable key length supported by the potential recipient device.

As is shown, upon receiving the digital signed encryption certificate, the potential sender device may verify the authenticity of the received digital encryption certificate based on one or both of a public signing key associated with the potential recipient or a digital signing certificate issued by a party trusted by the potential recipient and the potential sender, block 224. In various embodiments the verifying may comprise verifying a signature of the digital encryption certificate, the digital encryption certificate signed with a private signing key of a signing key pair of the recipient. In such embodiments, the potential sender device may use the public signing key of the potential recipient to verify the signature.

Upon verifying the authenticity of the digital encryption certificate, the potential sender device may determine whether one or both of the digital encryption certificate and/or the digital signing certificate are expired or revoked, block 226. In various embodiments, the determining may comprise checking a certificate revocation list associated with the trusted party to see if either or both of the certificates are listed.

If the certificates are not revoked, the potential sender device may then encrypt a digital message to be sent the recipient using the first encryption key, block 228, and may send the encrypted message to the potential recipient, block 230. In one embodiment, the encrypting may further comprise encrypting the digital message using the symmetric encryption algorithm, and then in turn further encrypting the message using the first encryption key, such as a public encryption key, of the digital encryption certificate. In other embodiments, other data in the digital encryption certificate may also or instead be used for message encryption.

FIG. 3 illustrates an exemplary computing device capable of performing the operations of various embodiments of the present invention. As shown, computing system/device 300 may include one or more processors 302, and system memory 304. Additionally, computing system/device 300 may include mass storage devices 306 (such as diskette, hard drive, CDROM and so forth) that may be removable, input/output devices 308 (such as keyboard, cursor control and so forth) and communication interfaces 310 (such as network interface cards, modems and so forth). The elements may be coupled to each other via system bus 312, which represents one or more buses. In the case of multiple buses, they may be bridged by one or more bus bridges (not shown).

System memory 304 and mass storage 306 may be employed to store a working copy and a permanent copy of the programming instructions implementing one or more aspects of the above described teachings to practice the present invention, such as computational logic 314. The programming instructions may be implemented in assembler instructions supported by processor(s) 302 or high level languages, such as C, that may be compiled into such instructions. The permanent copy of the programming instructions may be placed into permanent storage 306 in the factory, or in the field, through e.g. a distribution medium (not shown) or through communication interface 310 (from a distribution server (not shown)). Further, the programming instructions may comprise one or more of the operations described herein, and may be embodied on an article of manufacture, including a magnetic or optical disc, that may be operatively coupled with the processor(s) 302 to provide reading, writing, and/or storage of the programming instructions and/or data.

Although specific embodiments have been illustrated and described herein for purposes of description of the preferred embodiment, it will be appreciated by those of ordinary skill in the art that a wide variety of alternate and/or equivalent implementations may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A method comprising:
generating, by a potential recipient device of a potential recipient of one or more digital messages, a digital encryption certificate, the digital encryption certificate including a first encryption key of an encryption key pair;
signing, by the potential recipient device, the digital encryption certificate with a first signing key of a signing key pair, the signing key pair having a publicly-accessible second signing key associated with a digital signing certificate issued by a party trusted by the potential recipient and one or more potential senders; and
placing, by the potential recipient device, the encryption certificate in a location accessible to potential sender devices of the potential senders.

2. The method of claim 1, wherein the signing key pair includes a public and a private signing key, and said signing the digital encryption certificate with the first signing key comprises signing the digital encryption certificate with the private signing key.

3. The method of claim 1, further comprising generating the encryption key pair, the encryption key pair comprising a public encryption key and a private encryption key, wherein the first key of the encryption key pair is the public encryption key.

4. The method of claim 3, further comprising storing the private encryption key in one or both of a keystore and/or a key escrow.

5. The method of claim 1, further comprising receiving the digital signing certificate from the trusted party, the trusted party providing the digital signing certificate in response to receiving, from the potential recipient, the second signing key of the signing key pair.

6. The method of claim 1, wherein the digital encryption certificate further includes at least one of (a) potential recipient identity information, (b) an identification of a symmetric encryption algorithm, (c) an expiration date of one or both of the digital encryption certificate and the digital signing certificate, (d) the digital signing certificate, (e) a reference to the digital signing certificate, or (f) a maximum, minimum, or acceptable key length supported by the potential recipient device.

7. The method of claim 1, further comprising revoking one or both of the digital encryption and/or signing certificates.

8. The method of claim 1, further comprising receiving a digital message encrypted with the first key of the encryption key pair, and decrypting the digital message with a second key of the encryption key pair.

9. A method comprising:
receiving, by a potential sender device of a potential sender of one or more digital messages, a digital encryption certificate of a potential recipient, the digital encryption certificate including a first encryption key of an encryption key pair;
verifying, by the potential sender device, authenticity of the received digital encryption certificate based on one or both of a public signing key associated with the potential recipient or a digital signing certificate issued by a party trusted by the potential recipient and the potential sender;
encrypting, by the potential sender device, a digital message to be sent the recipient using the first encryption key; and
sending, by the potential sender device, the encrypted message to the potential recipient.

10. The method of claim 9, wherein said verifying comprises verifying a signature of the digital encryption certificate, the digital encryption certificate signed with a private signing key of a signing key pair of the recipient.

11. The method of claim 10, wherein said verifying the signature comprises using the public signing key of the potential recipient to verify the signature.

12. The method of claim 9, further comprising determining whether one or both of the digital encryption certificate and/or the digital signing certificate are expired or revoked.

13. The method of claim 12, wherein said determining comprises checking a certificate revocation list associated with the trusted party.

14. The method of claim 12, wherein said encrypting and said sending are performed conditionally, based on a result of said determination.

15. The method of claim 9, wherein the digital encryption certificate further includes at least one of (a) potential recipient identity information, (b) an identification of a symmetric encryption algorithm, (c) an expiration date of one or both of the digital encryption certificate and the digital signing certificate, (d) the digital signing certificate, (e) a reference to the digital signing certificate, or (f) a maximum, minimum, or acceptable key length supported by the potential recipient.

16. The method of claim 15, wherein said encrypting further comprises encrypting the digital message using the symmetric encryption algorithm in addition to the first encryption key.

17. An apparatus comprising:
a processor; and
logic operated by the processor and adapted
(1) to generate a first digital encryption certificate, the first digital encryption certificate including a first encryption key of a first encryption key pair, to sign the first digital encryption certificate with a first signing key of a signing key pair, the signing key pair having a publicly-accessible second signing key associated with a first digital signing certificate issued by a party trusted by a potential digital message recipient user of the apparatus and one or more potential senders of digital message, and to place the first encryption certificate in a location accessible to potential senders, and/or
(2) to receive a second digital encryption certificate of a potential recipient, the second digital encryption certificate including a first encryption key of a second encryption key pair, to verify the authenticity of the second digital encryption certification based on one or both of a public signing key associated with another potential digital message recipient user or a second digital signing certificate issued by the trusted party, to encrypt a digital message to the other potential digital message recipient using the first encryption key of the second encryption key pair, and to send the encrypted message to the other potential recipient.

18. The apparatus of claim 17, wherein the first/second digital encryption certificate further includes at least one of (a) potential recipient identity information, (b) an identification of a symmetric encryption algorithm, (c) an expiration date of one or both of the first/second digital encryption certificate and the first/second digital signing certificate, (d) the first/second digital signing certificate, (e) a reference to the first/second digital signing certificate, or (f) a maximum, minimum, or acceptable key length supported by the potential recipient.

19. An article of manufacture comprising:
a storage medium; and
a plurality of programming instructions stored on the storage medium and configured to program an apparatus
(1) to generate a first digital encryption certificate, the first digital encryption certificate including a first encryption key of a first encryption key pair, to sign the first digital encryption certificate with a first signing key of a signing key pair, the signing key pair having a publicly-accessible second signing key associated with a first digital signing certificate issued by a party trusted by a potential digital message recipient user of the apparatus and one or more potential senders of digital message, and to place the first encryption certificate in a location accessible to potential senders, and/or
(2) to receive a second digital encryption certificate of a potential recipient, the second digital encryption certificate including a first encryption key of a second encryption key pair, to verify the authenticity of the second digital encryption certification based on one or both of a public signing key associated with another potential digital message recipient user or a second digital signing certificate issued by the trusted party, to encrypt a digital message to the other potential digital message recipient using the first encryption key of the second encryption key pair, and to send the encrypted message to the other potential recipient.

20. The article of claim 19, wherein the first/second digital encryption certificate further includes at least one of (a) potential recipient identity information, (b) an identification of a symmetric encryption algorithm, (c) an expiration date of one or both of the first/second digital encryption certificate and the first/second digital signing certificate, (d) the first/second digital signing certificate, (e) a reference to the first/second digital signing certificate, or (f) a maximum, minimum, or acceptable key length supported by the potential recipient.
